(19) United States
(12) Patent Application Publication
(10) Pub. No.: US 2021/0214104 A1
(43) Pub. Date: Jul. 15, 2021

(54) Forward-Launching Method and Device for Aircraft and Spacecraft

(71) Applicant: Yuanming Yi, Shenzhen (CN)

(72) Inventor: Yuanming Yi, Shenzhen (CN)

(21) Appl. No.: 16/071,694

(22) PCT Filed: Jul. 13, 2018
(86) PCT No.: PCT/CN2018/095619

§ 371 Date: Feb. 16, 2021

(51) Int. Cl. B64G 1/00; B64G 1/40

(52) U.S. Cl. CPC B64G 1/002; B64G 1/40

(57) ABSTRACT

The invention relates to a forward-launching method and device for aircraft and spacecraft, characterized in that a launching booster arranged on the ground is used to efficiently generate forward-launching thrust and kinetic energy to propel the aircraft and spacecraft to generate a off-ground speed as high as possible, and against this background, an aircraft and spacecraft engine is ignited for work, thereby greatly reducing invalid load of fuel and oxygen as carried by the aircraft and spacecraft to highly improve thermal efficiency of aerospace engineering and significantly reduce the energy consumption cost of the aerospace engineering.

### FIELD OF THE INVENTION

The present invention relates to a launching method and device for aircraft and spacecraft, in particular to a forward-launching method and device for aircraft and spacecraft for significantly improving thermal efficiency and payload of aerospace engineering.

### BACKGROUND

The launching methods and devices for aircraft and spacecraft as used at present are all rearward-launching methods and devices, which promote travel of aircraft and spacecraft by placing all fuel and oxygen required during the entire voyage in a booster rocket and using rearward-launching force generated out of gas at the rear end of the rocket. Since the fuel and oxygen constitute weight load of the aircraft and spacecraft, the aircraft and spacecraft cannot achieve the ideal acceleration, speed and voyage; since the weight of the gas immediately ejected from the rear end of the booster rocket at a high speed is greatly lower than the self-weight of the aircraft and spacecraft, most of thermal kinetic energy generated by the existing aircraft and spacecraft engine is wasted; accordingly, the existing aircraft and spacecraft have very little payload, and energy consumption cost for the aerospace engineering is extremely high. Although the existing aircraft carriers use boosting launching methods and devices, such as ejection, for shipborne aircrafts, the purpose thereof merely resides in reducing the length of deck for air planes' taking off and skidding, and further, its use is extremely limited.

### SUMMARY OF THE INVENTION

The object of the present invention is to provide a new forward-launching method and device for aircraft and spacecraft, which significantly improve thermal efficiency of aerospace engineering, greatly reduce energy consumption cost of aircraft and spacecraft, and improve payload of aircraft and spacecraft.

The technical solution of the present invention is as follows:

A forward-launching method for aircraft and spacecraft may be a method in which the manner of forming a speed for the existing aircraft and spacecraft completely using rearward-launching thrust generated by ejecting gas backward from a booster rocket is modified into a manner of efficiently generating forward-launching thrust and kinetic energy using a launching booster arranged on the ground to promote aircraft and spacecraft to produce an off-ground speed as high as possible, whereby igniting aircraft and spacecraft engines for work.

In one embodiment, by using a ground launching booster, the aircraft and spacecraft is firstly promoted to generate an off-ground speed as high as possible so as to greatly reduce aeronautical and aerospace propulsion tasks undertaken by the aircraft and spacecraft engine carried by the aircraft and spacecraft, thereby greatly reducing fuel and oxygen carried by the aircraft and spacecraft. In accordance with the physical principle F=ma, ground acceleration of the aircraft and spacecraft at the initiation phase and navigation acceleration generated under the action of rearward-launching force produced by the carried aircraft and spacecraft engines are greatly enhanced.

In general, the thermal work process of a thermal engine is a process in which an internal force acts in an object system composed of two objects. In the course of its action, since the magnitude of the internal force experienced by the two objects may be exactly the same as the acting time of the internal force, the momentum generated by the two objects due to the internal force may be completely equal. At the same time, due to different masses of the two objects, the amount of thermal kinetic energy obtained during their respective internal force action may vary depending on the masses of both. The object having a large mass obtains less thermal kinetic energy, the object having a small mass obtains more thermal kinetic energy, and the ratio of both is inversely proportional to the mass of both. The thermal kinetic energy obtained by the existing aircraft and spacecraft from the above-mentioned thermal work process may be determined by the inverse ratio of the mass of the aircraft and spacecraft to the mass of gas instantaneously ejected from the aircraft and spacecraft engine, resulting in extremely low thermal efficiency.

In on embodiment, by arranging a launching booster on the ground, a thermal working system in the booster makes the internal force action occur between the aircraft and spacecraft and the earth. Since the ratio of the mass of the aircraft and spacecraft to the earth mass is infinitely small, the thermal kinetic energy obtained by means of the internal force action in the aircraft and spacecraft may approach 100% of the total amount of thermal kinetic energy generated by the thermal working system. As compared with the extremely low thermal efficiency of the existing aircraft and spacecraft engines, the thermal efficiency at the initiation phase of the aerospace engineering may be highly improved.

In one embodiment, under the action of the rearward-launching thrust generated by the aircraft and spacecraft engines carried by the aircraft and spacecraft, the action distance of the rearward-launching thrust meets the formula S=V₀t+½·at² under the condition that the aircraft and spacecraft has the above-mentioned off-ground speed as high as possible, and the action distance of the rearward-launching thrust meets the formula S=½·at² under the condition that the aircraft and spacecraft does not have the above-mentioned off-ground speed. Since V₀t+½·at² is much larger than ½·at², the propulsion kinetic energy produced by the rearward-launching thrust for the aircraft and spacecraft having the above-mentioned off-ground speed as high as possible may be much larger than that produced by the rearward-launching thrust for the aircraft and spacecraft without the above-mentioned off-ground speed.

In one embodiment, by means of the forward-launching thrust and kinetic energy efficiently generated by the ground launching booster first of all, the aircraft and spacecraft is driven to generate an off-ground speed as high as possible, and against this background, the aircraft and spacecraft engine as carried is ignited to generate rearward-launching thrust for propelling the aircraft and spacecraft under the conditions of having the above-mentioned off-ground speed as high as possible and a large force action distance, thereby enhancing the propulsion kinetic energy produced by the rearward-launching thrust, which is generated by the aircraft and spacecraft engine, for the aircraft and spacecraft.

In the present invention, the aircraft and spacecraft refers to an aircraft that navigates in a thin atmosphere and in the space after passing through a dense atmosphere. It may be a spacecraft travelling towards deep universe, and may also be an artificial satellite and space station travelling around the ground in the thin atmosphere and the space near the field; it may further be an aeronautical aircraft and medium- or long-range missile that navigates in a thin atmosphere.

In one embodiment, in the present invention, the launching booster arranged on the ground efficiently generates forward-launching thrust and kinetic energy for propelling the aircraft and spacecraft to generate an off-ground speed as high as possible, and against this background, the aircraft and spacecraft engine may be then ignited for work. According to the above process for ignition for work, the aircraft and spacecraft engine may be ignited for work just after leaving the ground, may also be ignited for work after passing through a dense atmosphere, and may further be ignited for work after the spacecraft engine passes through the entire atmosphere.

A forward-launching device for aircraft and spacecraft may comprise an aircraft and spacecraft, an aircraft and spacecraft engine, an aircraft and spacecraft inner chamber, an aircraft and spacecraft fuel chamber, an aerospace oxygen chamber, an isothermal compressive air compressor, a high pressure air chamber, a heater, a cylinder, a sliding piston tube, a bracket platform, a launcher body, a gas turbine generator, and an automatic switching valve.

In one embodiment, the isothermal air compressor and the gas turbine generator are arranged at the bottom of the launcher body, the high pressure air chamber is arranged at the central part of the launcher body, the cylinder is arranged around the high pressure air chamber, and the aircraft and spacecraft is placed on the bracket platform above the launcher body. In one embodiment, an air inlet of the isothermal air compressor is connected to a natural space, and an air outlet of the isothermal air compressor is connected to the high pressure air chamber via an automatic switching valve, the heater is disposed at the center in the high pressure air chamber, the high pressure air chamber may be connected to the cylinder via the automatic switching valve, the sliding piston tube is arranged within the cylinder, and the bracket platform for supporting the aircraft and spacecraft is secured to the upper end of the sliding piston tube. An air inlet of the gas turbine generator may be connected to the high pressure air chamber via the automatic switching valve, and an air outlet of the gas turbine generator is connected to the natural space.

In one embodiment, the isothermal air compressor draws normal-temperature air from the natural space, compresses it into high pressure air isothermally, and then inputs the high pressure air into the high pressure air chamber. After the air pressure reaches the predetermined value, the heater may rapidly heats the high pressure air, and the expanded high-temperature high pressure air may push the sliding piston tube within the cylinder to rise rapidly, and additionally push the aircraft and spacecraft on the bracket platform to generate an off-ground speed as high as possible. After launching the aircraft and spacecraft, the high-temperature high pressure air within the cylinder and high pressure air chamber may drive the gas turbine generator to run for power generation, thermal working medium exhaust may be discharged to the natural space, and the sliding piston tube in the cylinder may be lowered back to an initial position, thereby forming a thermal working system in the ground launching booster.

In the present invention, the heater may be a heater which can be energized to generate an electric spark, a heater which generates high-temperature heat by burning hydrogen, or a heater which generates high-temperature heat by burning oil.

In the present invention, the forward-launching device for aircraft and spacecraft is disposed on the earth's ground, which means that the above-mentioned launcher may be fastened to the ground and may also move freely on the ground.

In one embodiment, the present invention utilizes a forward-launching method and device for aircraft and spacecraft, which generates thrust and kinetic energy with high efficiency by means of the forward-launching booster disposed on the ground, promotes the aircraft and spacecraft to generate an off-ground speed as high as possible, and then ignites the aircraft and spacecraft engine for work, so as to greatly reduce fuel and oxygen carried by the aircraft and spacecraft and greatly improve thermal efficiency of aerospace engineering, thereby greatly increasing the payload of the aircraft and spacecraft and significantly reducing the energy consumption cost of the aerospace engineering.

### BRIEF DESCRIPTION OF THE DRAWINGS

The present invention will now be described in detail in conjunction with the drawings.

FIG. 1 is a schematic view showing the structure of a forward-launching method and device for aircraft and spacecraft.

### DETAILED DESCRIPTION OF THE INVENTION

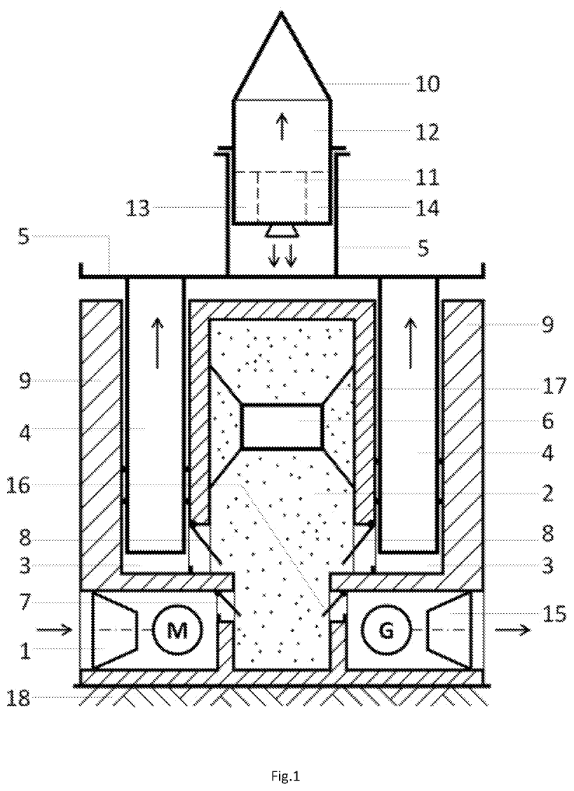

In one embodiment, referring to FIG. 1, a forward-launching method and device for aircraft and spacecraft according to the present invention generates forward-launching thrust and kinetic energy with high efficiency by means of a launching booster disposed on the ground, promotes an aircraft and spacecraft to generate an off-ground speed as high as possible, and then ignites and jets an aircraft and spacecraft e engine for work.

The forward-launching method for aircraft and spacecraft according to the present invention may be characterized in that a launching booster disposed on the ground is used to generate forward-launching thrust and forward-launching kinetic energy to drive the aircraft and spacecraft to generate an off-ground speed as high as possible, and then to ignite and jet an aircraft and spacecraft engine for work.

Firstly, an automatic switching valve between a high pressure air chamber and a gas turbine generator may be closed, and in the meantime, an automatic switching valve between the high pressure air chamber and a cylinder may also be closed. An isothermal air compressor in the launching booster arranged on the ground may be electrically driven to extract air from a natural space and compress it into high pressure air, and then enable the high pressure air to enter a high pressure air chamber via the automatic switching valve. When the air pressure within the high pressure air chamber reaches the predetermined value, an automatic switching valve between the high pressure air chamber and the isothermal air compressor may be closed, a heater may be initiated to heat, and meanwhile, the automatic switching valve between the high pressure air chamber and the cylinder may be opened. In one embodiment, high-temperature high pressure air enters the cylinder through the high pressure air chamber to drive a sliding piston tube within the cylinder to rise rapidly, and the sliding piston tube simultaneously propels the aircraft and spacecraft placed on a bracket platform to generate an off-ground speed as high as possible. In the meantime, the aircraft and spacecraft engine as carried by the aircraft and spacecraft may be ignited for work, and rearward-launching thrust generated by gas drives the aircraft and spacecraft to rise at an extremely high speed. Forward-launching thrust and forward-launching kinetic energy as generated by the gas interact with forward-launching force and forward-launching kinetic energy in the reverse direction as carried by the bracket platform and sliding piston tube. After the sliding piston tube reaches an upper stopping position set in the cylinder, the automatic switching valve disposed between the high pressure air chamber and the gas turbine generator may be opened, and the high-temperature high pressure air may enter the gas turbine generator from the high pressure air chamber and cylinder so as to drive the gas turbine generator to run for power generation. Finally, the bracket platform and the sliding piston tube may descend back to an initial position.

In one embodiment, the forward-launching device for aircraft and spacecraft according to the present invention is implemented using the above method. As shown in FIG. 1, a forward-launching device for aircraft and spacecraft may comprise: an isothermal compressive air compressor 1, a high pressure air chamber 2, a cylinder 3, a sliding piston tube 4, a bracket platform 5, a heater 6, an automatic switching valve 7, an automatic switching valve 8, a launching body 9, an aircraft and spacecraft 10, an aircraft and spacecraft engine 11, an aircraft and spacecraft inner chamber 12, an aircraft and spacecraft fuel chamber 13, a spacecraft oxygen chamber 14, a gas turbine generator 15, an automatic switching valve 16, a heater fixing bracket 17, and a launcher mounting ground 18; the isothermal compressive air compressor 1 and the gas turbine generator 15 are disposed at the bottom of the launcher body 9, the high pressure air chamber 2 may be disposed in the middle of the launcher body 9, the heater 6 may be disposed at the center position of the high pressure air chamber 2 via the fixing bracket 17, the cylinder 3 is arranged in the periphery around the high pressure air chamber 2, the sliding piston tube 4 slides within the cylinder 3 in the longitudinal direction, the bracket platform 5 is secured to the upper end of the sliding piston tube 4, the cylinder 3 is connected to the high pressure air chamber 2 via the automatic switching valve 8, the isothermal compressive air compressor 1 may be connected to the natural space via an air inlet, an air outlet of the isothermal compressive air compressor 1 may be connected to the high pressure air chamber 2 via the automatic switching valve 7, and an air inlet of the gas turbine generator 15 may be connected to the high pressure air chamber 2 via the automatic switching valve 16, an air outlet of the gas turbine generator 15 may be connected to the natural space, the aircraft and spacecraft 10 may be mounted on the bracket platform 5, the aircraft and spacecraft 10 may be provided with the aircraft and spacecraft engine 11, the aircraft and spacecraft inner chamber 12, the aircraft and spacecraft fuel chamber 13, and the spacecraft oxygen chamber 14 therein, constituting a forward-launching device for aircraft and spacecraft.

The isothermal air compressor 1 may draw normal-temperature air from the natural space, compress it into high pressure air isothermally, and may then input the high pressure air into the high pressure air chamber 2. After the air pressure reaches the predetermined value, the heater 6 rapidly heats the high pressure air, and the expanded high-temperature high pressure air pushes the sliding piston tube 4 within the cylinder 3 to rise rapidly, and additionally pushes the aircraft and spacecraft 10 on the bracket platform 5 to generate a off-ground speed as high as possible. After launching the aircraft and spacecraft 10, the high-temperature high pressure air within the cylinder 3 and high pressure air chamber 2 drives the gas turbine generator 15 to run for power generation, and the sliding piston tube 4 in the cylinder 3 may be lowered back to an initial position, thereby forming a thermal working system in the ground launching booster.

In the present invention, the heater 6 may be a heater which can be energized to generate an electric spark, a heater which generates heat by burning hydrogen, or a heater which generates heat by burning oil.

In the present invention, the forward-launching device for aircraft and spacecraft may be provided with a launcher body 9. The launcher body 9 may be fastened to the earth's ground 18 and may also move freely on the earth's ground 18.

Referring to FIG. 1, the forward-launching device for aircraft and spacecraft of the present invention may be operated according to the following procedure:

1. Closing the automatic switching valve 8 and the automatic switching valve 16, and opening the automatic switching valve 7;

2. Energizing and initiating the isothermal compressive air compressor 1 to extract air from the natural space and compress it into high pressure air, the high pressure air entering into the high pressure air chamber 2 via the automatic switching valve 7;

3. Initiating the heater 6 when the air pressure in the high pressure air chamber 2 reaches the set valve and opening the automatic switching valve 8 when the high pressure air is expanded by absorbing heat;

4. The high-temperature high pressure air entering the cylinder 3 to push the sliding piston tube 4, bracket platform 5 and aircraft and spacecraft 10 to rise rapidly, and initiating the aircraft and spacecraft engine 11 within the aircraft and spacecraft 10 for work when the bottom of the sliding piston tube 4 reaches the set upper stopping position within the cylinder 3;

5. Opening the automatic switching valve 16 after the aircraft and spacecraft 10 leaves the bracket platform 5, the high-temperature high pressure air entering the gas turbine generator 15 via the switching valve 16 to drive the gas turbine generator 15 for power generation, and the thermal medium exhaust being discharged to the natural space;

6. The bracket platform 5 and the sliding piston tube 4 falling back to the initial position as the air pressure in the cylinder 3 descends.

In the forward-launching method and device for aircraft and spacecraft of the present invention, a launching booster arranged on the ground may be utilized to efficiently produce forward-launching thrust and kinetic energy to push the aircraft and spacecraft to generate an off-ground speed as high as possible, and against this background, the aircraft and spacecraft engine may be ignited for work, thereby greatly reducing invalid load of the aircraft and spacecraft to highly improve thermal efficiency of aerospace engineering and significantly reduce the energy consumption cost of the aerospace engineering. The invention may be widely used, and the principles, industrial and commercial applications of the present invention are included in the scope of the claims of the present invention, and any improved technique based thereon may be taken from the claims of the present invention.

What is claimed includes:

1. A forward-launching method for aircraft and spacecraft using a thermal engine to promote travel of the aircraft and spacecraft characterized in that a launching booster arranged on the ground is used to efficiently generate forward-launching thrust and kinetic energy to propel the aircraft and spacecraft to generate an off-ground speed as high as possible, and against this background, an aircraft and spacecraft engine is ignited for work.

2. The method according to claim 1, wherein by using a ground launching booster, the aircraft and spacecraft is firstly promoted to generate an off-ground speed as high as possible so as to greatly reduce aeronautical and aerospace propulsion tasks undertaken by the aircraft and spacecraft engine, thereby greatly reducing fuel and oxygen carried by the aircraft and spacecraft, and according to a physical principle F=ma, ground acceleration of the aircraft and spacecraft at an initiation phase and navigation acceleration generated under the action of rearward-launching force produced by the aircraft and spacecraft engines are greatly enhanced.

3. The method according to claim 1, wherein by using a launching booster arranged on the ground, a thermal working system in the booster makes an internal force action occur between the aircraft and spacecraft and earth's ground, since the ratio of the mass of the aircraft and spacecraft to earth's mass is infinitely small, thermal kinetic energy obtained by means of the internal force action in the aircraft and spacecraft approaches 100% of a total amount of thermal kinetic energy generated by the thermal working system, and as compared with an extremely low thermal efficiency of existing aircraft and spacecraft engines, the thermal efficiency at an initiation phase of aerospace engineering is highly improved.

4. The method according to claim 1, wherein by means of the forward-launching thrust and kinetic energy efficiently generated by the ground launching booster first of all, the aircraft and spacecraft is driven to generate the off-ground speed as high as possible, and against this background, the aircraft and spacecraft engine as carried is ignited to generate rearward-launching thrust for propelling the aircraft and spacecraft under conditions of having the above-mentioned off-ground speed as high as possible and a large force action distance, thereby enhancing a propulsion kinetic energy produced by the rearward-launching thrust, which is generated by the aircraft and spacecraft engine, for the aircraft and spacecraft.

5. The method according to claim 1 characterized in that the aircraft and spacecraft refers to an aircraft that navigates in a thin atmosphere and in the space after passing through a dense atmosphere, which may be a spacecraft travelling towards deep universe, and may also be an artificial satellite and space station travelling around the ground in the thin atmosphere and a space near the field, and may further be an aeronautical aircraft and medium- or long-range missile that navigates in a thin atmosphere.

6. The method according to claim 1, wherein the launching booster arranged on the ground efficiently generates forward-launching thrust and kinetic energy for propelling the aircraft and spacecraft to generate the off-ground speed as high as possible, and against this background, the aircraft and spacecraft engine is then ignited for work, and the aircraft and spacecraft engine may be ignited for work just after leaving the ground, may also be ignited for work after passing through a dense atmosphere, and may further be ignited for work after the spacecraft engine passes through the entire atmosphere.

7. A forward-launching device for aircraft and spacecraft comprising an aircraft and spacecraft, an aircraft and spacecraft engine, an aircraft and spacecraft inner chamber, an aircraft and spacecraft fuel chamber, and an aerospace oxygen chamber, characterized in that the forward-launching device for aircraft and spacecraft further comprises: an isothermal air compressor, a high pressure air chamber, a heater, a cylinder, a sliding piston tube, a bracket platform, a launcher body, a gas turbine generator, and an automatic switching valve, wherein the isothermal air compressor and the gas turbine generator are arranged at a bottom of the launcher body, the high pressure air chamber is arranged at a central part of the launcher body, the cylinder is arranged around the high pressure air chamber, and the aircraft and spacecraft is placed on the bracket platform above the launcher body; wherein an air inlet of the isothermal air compressor is connected to a natural space, and an air outlet of the isothermal air compressor is connected to the high pressure air chamber via an automatic switching valve, the heater is disposed at the center in the high pressure air chamber, the high pressure air chamber is connected to the cylinder via the automatic switching valve, the sliding piston tube is arranged within the cylinder, and the bracket platform for supporting the aircraft and spacecraft is secured to the upper end of the sliding piston tube; wherein an air inlet of the gas turbine generator is connected to the high pressure air chamber via the automatic switching valve, and an air outlet of the gas turbine generator is connected to the natural space; wherein the isothermal compressive air compressor draws normal-temperature air from the natural space, compresses it into high pressure air isothermally, and then inputs the high pressure air into the high pressure air chamber; after the air pressure reaches the predetermined value, the heater rapidly heats the high pressure air, and the expanded high-temperature high pressure air pushes the sliding piston tube within the cylinder to rise rapidly, and additionally pushes the aircraft and spacecraft on the bracket platform to generate an off-ground speed as high as possible; after launching the aircraft and spacecraft, the high-temperature high pressure air within the cylinder and high pressure air chamber drives the gas turbine generator to run for power generation, thermal working medium exhaust is discharged to the natural space, and the sliding piston tube in the cylinder is lowered back to an initial position, thereby forming a thermal working system in a ground launching booster.

8. The forward-launching device for aircraft and spacecraft according to claim 7, characterized in that the heater may be a heater which can be energized to generate an electric spark, a heater which generates heat by burning hydrogen, or a heater which generates heat by burning oil.

9. The forward-launching device for aircraft and spacecraft according to claim 7, characterized in that the forward-launching device for aircraft and spacecraft is disposed on earth's ground, which means that the launcher may be fastened to a ground and may also move freely on the ground.
